(19) United States
(12) Patent Application Publication
(10) Pub. No.: US 2005/0116068 A1
(43) Pub. Date: Jun. 2, 2005

(54) Injection nozzle with a fuel filter

(76) Inventors: Gunter Kampichler, Ruhstorf (DE); Herbert Geier, Ruhstorf (DE)

Correspondence Address: KATTEN MUCHIN ZAVIS ROSENMAN, 575 MADISON AVENUE, NEW YORK, NY, 10022-2585, US

(21) Appl. No.: 10/504,280

(22) PCT Filed: Feb. 1, 2003
(86) PCT No.: PCT/EP03/01014

(30) Foreign Application Priority Data
Feb. 27, 2002 (DE) 102 08 544.7

(51) Int. Cl. F02M 59/00; F02M 61/00; F02M 39/00; F02M 63/00

(52) U.S. Cl. 239/575; 239/533.2; 239/533.3

(57) ABSTRACT

In an injection nozzle (1) with fuel filter for reciprocating-piston internal-combustion engines, with a filter body (8) in the pressure line (13) of a nozzle holder (2) comprising holding body (3) and nozzle body (4), there are formed filter surfaces or filter slots by boreholes in the filter body (8) and filter elements disposed movably therein. The filter elements are loose balls (19), which form filter slots together with the walls of the boreholes (18), and thus can pulsate because of the flow and dynamically reduce the size of residues.

The invention relates to an injection nozzle with fuel filter for reciprocating-piston internal-combustion engines, with a filter body in the pressure line of a nozzle holder comprising holding body and nozzle body.

In injection nozzles, which are made of high-precision fitting parts, fuel filters are necessary in order to protect the sensitive components from particulate contaminants in the form of metal chips, detached burrs or the like in the fuel. Such fuel filters therefore prolong the useful life of the injection nozzle and ensure trouble-free operation thereof.

Known edge-type filter elements are inserted either in the holding body of the nozzle holder or outside this body, within screwed connecting couplings in the fuel pressure line. By a partition wall separated from the wall of the pressure duct by the width of a slot and extended in duct direction, they permit the collection of undesired residues in a dirt space on one side of the partition wall. The fuel washing around the partition wall in circumferential direction passes via a clean space on the clean side of the edge-type filter into the pressure duct leading to the nozzle body.

The effectiveness of such edge-type filters is limited, since they need so much installation space that they can be mounted only at a distance from the nozzle body, and since the residues progressively fill up the dirt space and in some cases remain caught in the filter slots. As a result, functional impairments occur and can be eliminated only by replacing the edge-type filter or the component housing it. Because of the tight-fitting pressed-in seat, metal particles may be detached in the process of mounting such edge-type filters.

In contrast, the object of the present invention is to provide, for injection nozzles, a fuel filter that is robust and largely maintenance-free and that in addition can operate with a relatively small filter surface, so that it can be positioned as close as possible to the nozzle needle.

For this purpose, it is proposed according to the invention that the filter surfaces or filter slots be formed by boreholes in the filter body and by filter elements disposed movably therein.

In this way there is achieved a dynamically acting fuel filter, in which loose filter elements disposed in the boreholes ensure that, by means of the filter elements, which pulsate with the flow, the residues arriving in the boreholes of the filter body are pounded apart, ground to pieces and thus reduced in size, until they reach a particle size that permits passage through the filter slot. It is precisely because of the dynamic size-reduction effect of the filter elements that a fuel filter with relatively small filter surface can be achieved, with slot dimensions that can be designed to match the structural configuration of the injection nozzle. Such a dynamic fuel filter is particularly suitable for injection nozzles of direct-injection engines, especially in those whose nozzles have boreholes in the seat and can no longer be adequately protected with the known edge-type filter.

According to a further configuration, there can be provided a plurality of boreholes through which the flow passes in parallel, depending on the size of the filter surface to be ensured. It is also possible to provide a plurality of filter elements in each borehole, in order to improve the size-reduction effect in this way.

It is particularly advantageous when the filter elements are balls, which together with the walls of the boreholes form filter slots, from which the filter surface is composed. Two or more of such balls can be disposed in series in one borehole. In this way there is achieved a particularly good size-reduction effect, because a plurality of balls pulsate not only in flow direction but also pulsate strongly transverse thereto, within the limits allowed by the existing filter slots.

To improve the size-reduction effect of the filter elements being moved by the intermittent fuel flow, it is provided according to the invention that the pressure line opens or discharges into prechambers of the filter body, which prechambers in turn communicate with the filter surface or with the filter slots. This means that both the pressure lines on the one hand and the boreholes on the other hand open into prechambers on the inlet and/or outlet side of the bores, by which prechambers the movement path of the filter elements or balls in flow direction is limited in a manner corresponding to the dimensioning of these prechambers. The residues present in the prechambers are crushed to pieces there in cooperation with the adjoining and preferably hardened component walls under the beating effect of the filter elements, which preferably are also hardened.

When balls are used as movable filter elements, it is expedient to choose a ball diameter that is 0.01 to 0.1 mm smaller than the borehole diameter, the maximum slot width then corresponding to this size.

In a preferred embodiment of the filter body, it has substantially the form of a disk, so that it can be advantageously clamped between holding body and nozzle body. In this case it simultaneously forms the intermediate plate that is usually present in injection nozzles. This plate is lapped on both sides, to ensure a leaktight connection relative to the pressure line by means of correspondingly machined surfaces of the holding body on the one hand and of the nozzle body on the other hand.

In such a disk-shaped filter body, it may be expedient for the prechambers to be formed by grooves, which are broader than the diameter of the boreholes. In the use of balls as filter elements, it is then expedient for the groove depth to be smaller than the ball radius, so that the ball is always held in the interior of the bores by virtue of its largest diameter.

Expediently, the groove shape is chosen in such a way that all boreholes open thereinto and that the pressure line is also connected thereto at a position offset relative to the boreholes. In this way communication with the filter surface or filter slots is established. In other words, the fuel flows from the pressure line in communication with the feed via the prechamber on the inlet side through the boreholes and the prechamber on the outlet side into the pressure line leading to the nozzle needle.

By the fact that the filter body is composed of a plurality of filter disks, the possibility exists that filter disks having recesses that correspond to the groove shape can be inserted instead of the slots that form the prechambers. Whereas the prechambers are formed by such filter disks, a further filter disk in which the boreholes are machined is necessary. When all filter disks have been assembled, they constitute the inventive filter body.

A preferred embodiment provides for four boreholes distributed within one half circumference and communicating with one another via a prechamber having the form of a partly circular groove. In the scope of the invention, however, the possibility exists of providing even more boreholes in the other half of the filter body, if a correspondingly enlarged filter surface is needed. Space must also be provided between the boreholes for mounting at least two fixing pins and the port for the fuel pressure line, this port being offset relative to the boreholes.

A practical example of the invention will be explained hereinafter with reference to the drawing, wherein

FIG. 1 shows an axial section through an injection nozzle along section lines I-I of FIG. 3

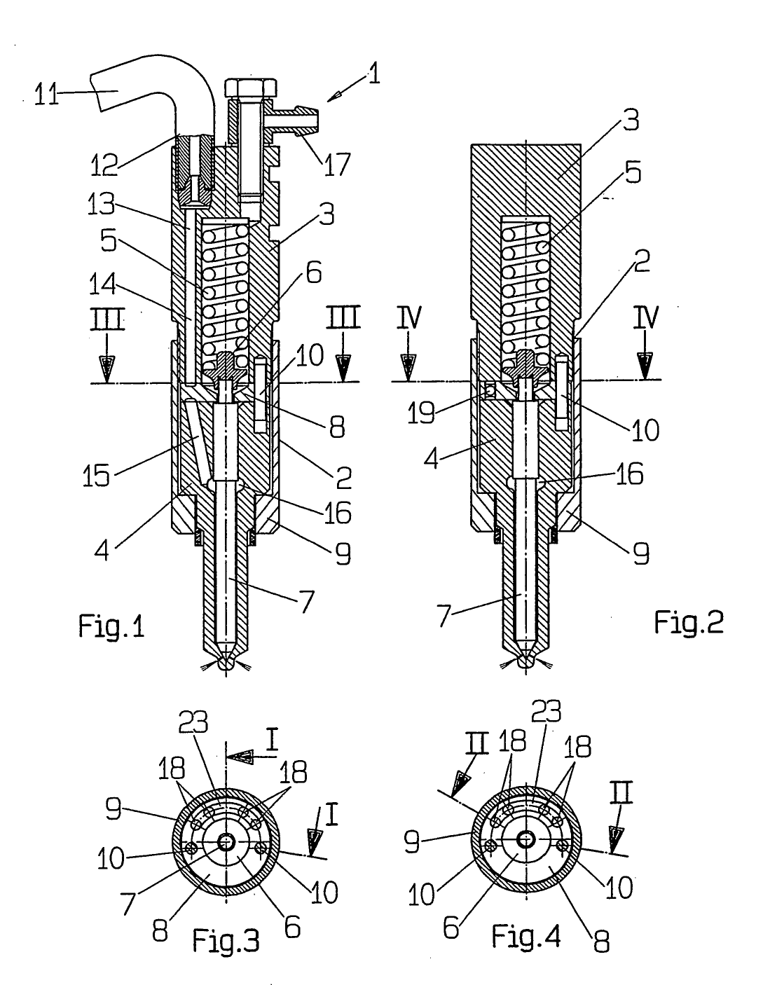

FIG. 2 shows an axial section through the injection nozzle according to FIG. 1, along section lines II-II of FIG. 4

FIG. 3 shows a cross section through FIG. 1 along III-III

FIG. 4 shows a cross section through FIG. 2 along IV-IV

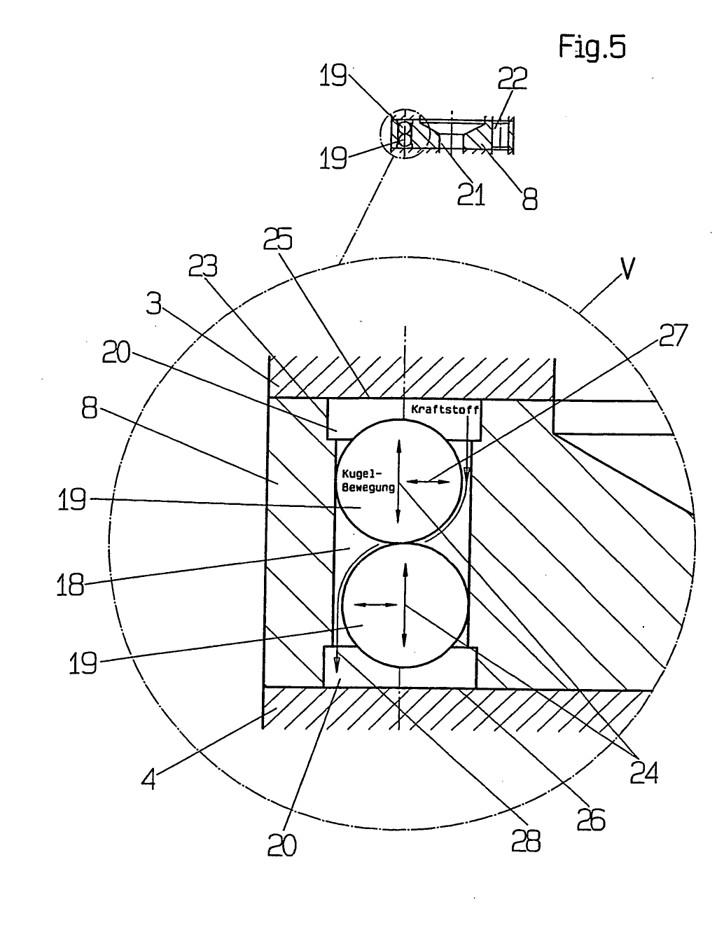

FIG. 5 shows an alternative version of the filter body with associated enlarged recess

FIGS. 1 to 4 show different sections through an injection nozzle 1, whose nozzle holder 2 comprises a holding body 3 and a nozzle body 4. In holding body 3 there is housed a compression spring 5, which is preloaded via a thrust pin 6 against a nozzle needle 7. Between holding body 3 and nozzle body 4 there is disposed an intermediate plate, which is designed as a disk-shaped filter body 8. Holding body 3 and nozzle body 4 are clamped together by means of a nozzle-clamping nut 9 and are centered relative to one another by means of two fixing pins 10. To the holding body there is connected a fuel feed 11 via a port connection 12 on pressure line 13, whose upper portion 14, via filter body 8 and a lower portion 15, is in communication with an annular space 16 for actuation of nozzle needle 7. At the upper end of the low-pressure space containing compression spring 5, there is provided a bleed port 17. Where the said components appear in FIGS. 1 to 4, they are denoted by like reference numerals. The sections according to FIGS. 3 and 4 show the same cross section; they differ merely by different particulars of the section lines of the associated axial sections according to FIGS. 1 and 2. Section line I-I according to FIG. 3 relates to the illustration according to FIG. 1; section line II-II according to FIG. 4 relates to the illustration according to FIG. 2. Whereas the section plane on the right side of the section illustration according to FIGS. 1 and 2 passes through a fixing pin 10 in each case, the sections on the left side differ from one another as regards their longitudinal axes; in FIG. 1, the corresponding section plane runs through fuel pressure line 13; in FIG. 2, the corresponding section plane runs through one of a total of four boreholes 18 in filter body 8. In each of these boreholes 18 there is disposed a filter element in the form of a ball 19, which during operation of the injection pump is hurled forward and back between stop faces, one formed by holding body 3 and the other by nozzle body 4. On both sides, between ball 19 and the associated stop faces, there is disposed a prechamber 20. For clarity of presentation, this is indicated more precisely in the enlargement of FIG. 5.

The filter body in the embodiment according to FIG. 5 differs from that according to FIGS. 1 to 4 only by the fact that two balls 19 are contained in borehole 18, whereas in the embodiment according to FIGS. 1 to 4 only a single ball 19 is provided, as is evident in FIG. 2. Otherwise FIG. 5 shows filter body 8 as such, or in other words with a central borehole 21 for nozzle needle 7 and a further borehole 22 for a fixing pin 10. The two end sides of filter body 8 are lapped, so that they bear leaktightly against the also lapped end sides of holding body 3 on the one hand and of nozzle body 4 on the other hand. Enlargement V of FIG. 5 illustrates how prechambers 20 are configured by a groove 23, which as shown in FIGS. 3 and 4 describes a partial circular arc and in this way allows all boreholes 18 to communicate with one another. Corresponding to the chosen groove depth, balls 19, under the action of the intermittent high-pressure flow in pressure line 13, beat against one another in the axial direction indicated by double arrow 24 or against the adjoining stop faces, which are formed by facing end side 25 of holding body 3 on the one hand and opposite end side 26 of nozzle body 4 on the other hand. Corresponding to their free travel in axial direction, balls 19 act in hammerlike manner against metal chips and similar residues as long as these are present in the area of action of balls 19. They can pass boreholes 18 if either they were originally smaller than the slot width shown between ball circumference and borehole wall in enlargement V or after they have been correspondingly reduced in size under the action of balls 19. Under this dynamic size-reduction action of balls 19, it is possible to grind residues of metal chips, burr parts and the like that accumulate in the prechambers to such small pieces that they can pass through the filter slots. In this way a maintenance-free fuel filter is obtained.

In the case of two balls disposed in series, this action is even further improved by the fact that the grinding action also takes place in the transverse direction indicated by double arrows 27, since the balls are always deflected relative to one another from their middle position. In the illustration corresponding to enlargement V, upper ball 19 is in left contact and lower ball 19 is in right contact with the wall of borehole 18, so that the maximum filter slot is formed in each case on the opposite side. In other words, balls 19 permit passage as indicated by curved arrow 28.

1. An injection nozzle (1) with fuel filter for reciprocating-piston internal-combustion engines, with a filter body (8) in the pressure line (13) of a nozzle holder (2) comprising holding body (3) and nozzle body (4),
characterized in that
the filter surfaces and filter slots are formed by boreholes (18) in the filter body (8) and by filter elements disposed movably therein.

2. An injection nozzle according to claim 1,
characterized in that
there is provided a plurality of boreholes (18) through which the flow passes in parallel.

3. An injection nozzle according to claim 1,
characterized in that
the pressure line (13) opens or discharges into prechambers (20) of the filter body (8), which prechambers communicate with the filter surface or with the filter slots.

4. An injection nozzle according to claim 1,
characterized in that
the filter body (8) has substantially the form of a disk and is clamped between holding body (3) and nozzle body (4).

5. An injection nozzle according to claim 4,
characterized in that
the filter body (8) is composed of a plurality of filter disks.

6. An injection nozzle according to claim 1,
characterized in that
the filter elements are balls (19), which together with the walls of the boreholes (18) form filter slots, from which the filter surface is composed.

7. An injection nozzle according to claim 6,
characterized in that
two or more balls (19) are disposed in series in one borehole (18).

8. An injection nozzle according to claim 3,
characterized in that
the prechambers (20) are formed by grooves (23), which are broader than the diameter of the boreholes (18).

9. An injection nozzle according to claim 8,
characterized in that
the groove depth is smaller than the ball radius.

10. An injection nozzle according to claim 6,
characterized in that
the ball diameter is 0.01 to 0.1 mm smaller than the borehole diameter.
